(19) United States
(12) Patent Application Publication
(10) Pub. No.: US 2025/0061626 A1
(43) Pub. Date: Feb. 20, 2025

(54) SELECTION OF AREAS OF DIGITAL IMAGES

(71) Applicant: Adobe Inc., San Jose, CA (US)

(72) Inventors: Xiaoyang Liu, Bellevue, WA (US); Zhe Lin, Clyde Hill, WA (US); Yuqian Zhou, Bellevue, WA (US); Sohrab Amirghodsi, Seattle, WA (US); Sarah Jane Stuckey, Petaluma, CA (US); Sakshi Gupta, San Jose, CA (US); Guotong Feng, San Jose, CA (US); Elya Schechtman, Seattle, WA (US); Connelly Stuart Barnes, Seattle, WA (US); Betty Leong, Los Altos, CA (US)

(73) Assignee: Adobe Inc., San Jose, CA (US)

(21) Appl. No.: 18/674,518

(22) Filed: May 24, 2024

Related U.S. Application Data
(60) Provisional application No. 63/520,230, filed on Aug. 17, 2023.

(51) Int. Cl. G06T 11/60; G06T 5/77; G06T 11/20; G06V 10/764

(52) U.S. Cl. CPC G06T 11/60; G06T 5/77; G06T 11/203; G06V 10/764; G06T 2207/20104

(57) ABSTRACT

Techniques for performing a digital operation on a digital image are described along with methods and systems employing such techniques. According to the techniques, an input (e.g., an input stroke) is received by, for example, a processing system. Based upon the input, an area of the digital image upon which a digital operation (e.g., for removal of a distractor within the area) is to be performed is determined. In an implementation, one or more metrics of an input stroke are analyzed, typically in real time, to at least partially determine the area upon which the digital operation is to be performed. In an additional or alternative implementation, the input includes a first point, a second point and a connector, and the area is at least partially determined by a location of the first point relative to a location of the second point and/or by locations of the first point and/or second point relative to one or more edges of the digital image.

### RELATED APPLICATIONS

This application claims the benefit of priority to U.S. Provisional Patent Application Ser. No. 63/520,230, filed on Aug. 17, 2023, the disclosure of which is incorporated by reference herein in its entirety.

### BACKGROUND

There are many digital processing systems (e.g., computer systems) that provide for the performance of digital operations on digital images (e.g., digital photographs, digital artwork or the like). For example, digital processing systems provide for digital operations such as color enhancement, shading, creating, distractor removal (e.g., removal of an unwanted objection or feature) and so on for digital images. Typically, the digital processing systems include programming (e.g., computer programs and/or applications) for performing these digital operations.

Often, it is desirable to perform a digital operation solely on a portion of a digital image. As such, many digital processing systems provide mechanisms (e.g., tools) for selecting a particular area of a digital image upon which a digital operation is to be performed. Conventional techniques to do so, however, are inefficient as involving manual selection between a multitude of option that are difficult to locate and thus involve specialized knowledge and result in inefficient use of computational resources.

### SUMMARY

An example method is described. The method includes: receiving, by a processing device, an input with respect to a digital image, the input specifying a first point, a second point, and a connection between the first point and the second point; detecting, by the processing device, the first point and the second point are disposed proximal to one or more edges of the digital image; responsive to the detecting, defining, by the processing device, an area of the digital image based on the first point, the second point, and the connection; selecting, by the processing device, the area automatically and without user intervention; and generating, by the processing device, an edited digital image by applying a digital image editing operation to the selected area.

As example system is also described. The system includes: a non-transitory computer readable storage media and a processing device in communication with the non-transitory computer readable media, the processing device configured to: receive, via a user interface, an input stroke disposed with respect to a digital image; obtain metrics describing the input stroke; classifying the input stroke as corresponding to a particular selection operation from a plurality of selection operations based on the metrics; performing the particular selection operation, the particular selection operation selecting an area of the digital image automatically and without user intervention; selecting a distractor within the area of digital image based on the particular selection operation using the input stroke; and generating an edited digital image by removing the distractor from the digital image.

Another example system is described. The system includes a computing device having hardware and a distractor area module implemented at least partially in the hardware of the computing device. The distractor area module is configured to: detect an input stroke on a digital image; classify the input stroke; and select an area of the digital image based upon the input stroke. The system also includes a distractor removal module implemented at least partially in the hardware of the computing device to identify and remove a distractor from the area of the digital image. Further, the system includes a rendering module implemented at least partially in hardware of the computing device to display the digital image having the distractor removed.

Depending on the implementation, the methods and systems can also be characterized as including several additional aspects. The detecting of the first point and the second point can include determining that the first point and the second point are within a threshold distance from the one or more edges. The one or more edges can be selected from a single edge or a first edge and a second edge from a plurality of edges of the digital image. The digital image can be edited using an inpainting operation. The connection can avoid intersecting with itself. The input stroke can be classified as an internal lasso operation based at least in part upon the input stroke including a first point of the input stroke within a threshold distance of a second point of the input stroke such that the area of the digital image is defined by a connection between the first point and the second point. The input stroke is classified as an edge adjacent lasso operation based at least in part upon the input stroke including a first point of the input stroke within a threshold distance of one or more edges of the digital image and a second point of the input stroke within a threshold distance of the one or more edges such that the area of the digital image is defined by the one or more edges and a connection between the first point and the second point. The input stroke is classified as a brush stroke, the brush stroke defining the area of the digital image as disposed underneath the input stroke in the user interface.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to perform selection operations and digital operations described herein.

FIG. 2 is a flow diagram of an example methodology of determining an area of a digital image and performing a digital operation on the digital image in accordance with techniques described herein.

FIG. 3 is an example of an input stroke applied to a digital image in accordance with techniques described herein.

FIG. 4 is an example of an input stroke and the determination of an area selected by the input stroke in accordance with techniques described herein.

FIG. 5 is an example of an input stroke and the determination of an area selected by the input stroke in accordance with techniques described herein.

FIG. 6 is an example of an input stroke and the determination of an area selected by the input stroke in accordance with techniques described herein.

FIG. 7 is an example of an input stroke applied to a digital image for determining an area of the digital image and the performance of a digital operation in accordance with techniques described herein.

FIG. 8 is an example of an input stroke applied to a digital image for determining an area of the digital image in accordance with techniques described herein.

FIG. 9 is an example of two input strokes applied to a digital image for determining areas of the digital image in accordance with techniques described herein.

FIG. 10 is an example of an input stroke applied to a digital image for determining an area of the digital image in accordance with techniques described herein.

FIG. 11 is an example of an input stroke applied to a digital image for determining an area of the digital image in accordance with techniques described herein.

FIG. 12 is an example of system having modules suitable for performing methods and techniques described herein

FIG. 13 illustrates an example system including various components of an example device that can be implemented as any type of computing device as described and/or utilize with reference to FIGS. 1-12 to implement embodiments of the techniques described herein.

### DETAILED DESCRIPTION

### Overview

There are numerous digital operations that can be performed on a digital image using computerized systems. For example, a digital image can be colored, shaded, contoured or the like. As another example, digital images can be edited by, for example, removal or addition of objects, contrast and color enhancement, application of filters and so on. For performance of these digital operations on selected areas without performing the operations on the entirely of a digital image, the computerized systems typically provide for one or more techniques to determine an area of the digital image upon which the digital operation is to be performed. To perform the proper digital operation on a selected area, the computerized systems typically provide a mechanism (e.g., a tool) that can be selected to identify the operation that is to be performed upon the area.

In conventional digital systems, a user who is creating and/or editing a digital image typically identify a type of selection operation that the user would like to select an area upon which digital operation is to be performed. Then, once the operation is chosen, the user will typically select an area upon which the digital operation is to be performed using the selection operation, e.g., brushing over the entire area or performing a lasso operation on the area. As an example, a user might remove a distractor (e.g., a telephone in a picture of a family) from a digital photograph by selecting a brush distractor removal operation and then brushing over the entire area of the distractor that is to be removed followed by signaling (e.g., by hitting enter) that the area has been completely selected so that a computerized systems will then remove the distractor. Such conventional systems are time and labor intensive.

Accordingly, techniques are described herein for increasing efficiency and/or reducing labor associated with the identification of a selection operation to be performed and/or determination of an area upon which a digital operation is to be performed. In an implementation, metrics of an input stroke are analyzed by a computing device, typically in real time, to choose a selection operation from a plurality of selection operations, where the metrics indicate that the chosen operation is the one intended by the input stroke. Upon choosing the selection operation by the computing device, the area is directly determined based upon the input stroke in accordance with the selection operation. In this way, the analysis of the input stroke by the computing device automatically determines the selection operation and/or the area selected by the stroke and/or selection operation so that a user may avoid continually switching between selection operations and/or may avoid performing labor intensive selection operations.

In an additional or alternative implementation, selecting an area of a digital image by the computing device includes the identification of when to use one or more edges of the digital image to aid in determining a selected area of the digital image. In some instances, an input stroke will have a first point (e.g., a start or distal point of the input stroke) and a second point (e.g., an end or distal point of the input stroke) that are both adjacent (e.g., within a threshold distance from) one or more edges of the digital image. In such implementation, the outer perimeter of the selected area is defined by a connection of the input stroke that extends from the first point to the second point and the one or more edges of the digital image. Selecting an area of a digital image in this manner by the computing device is particularly helpful for removal of distractors from the digital image since distractors are often near edges of digital images.

In an additional or alternative implementation, selection an area of a digital images by the computing device includes determining metrics of an input stroke for assisting in either or both of: i) determining a selection operation that is to be performed from a plurality of selection operations; and/or ii) determining the area upon which a digital operation is to be performed. In such an implementation, the metrics of the stroke can include, without limitation, accumulative angle, open-to-total distance ratio, cumulative number of deflection points, cumulative number of reflection points, distance-to-area ratio, edge adjacency, point adjacency and so on. As an example, an input stroke may include an open-to-total distance ratio such that it becomes clear that the user intends to perform a particular type of lasso operation (e.g., an internal lasso operation) to select an area of a digital image that substantially defined by the input stroke. In this example, both the type of selection operation and the area selected by the selection operation are determined from the input stroke.

It shall be understood that the selection of the digital operation and the determination of the area upon which that operation is to be performed may be dependent upon each other or independent from each other. The determination of the area of a digital image upon which a digital operation is to be performed can be employed for multiple different digital operations.

It shall also be understood that the implementations of the techniques described herein can be used separately or combined.

### Example Environment

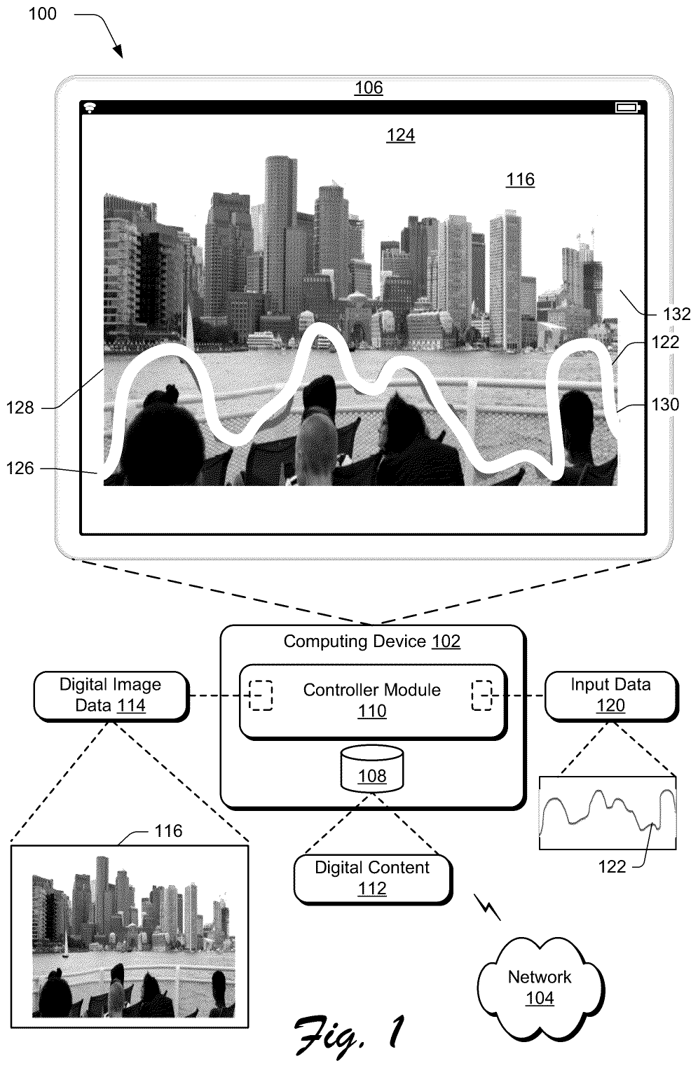

FIG. 1 is an illustration of an environment 100 in an example implementation that is operable to employ digital image selection techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106.

The computing device 102 includes a storage device 108 and a controller module 110. The storage device 108 is configured using a computer-readable storage medium for storing digital content 112 such as digital images, digital artwork, digital videos, digital media, and so forth.

The controller module 110 is illustrated as having, receiving, and/or transmitting digital image data 114 and input data 120 (e.g., an input stroke). In some examples, the controller module 110 receives the digital image data 114, the input data 120 or both via the network 104. For example, a user interacts with an input device (e.g., a mouse, a touchscreen, a keyboard, a stylus, etc.) to transmit the digital image data 114, the input data 120 or both to the controller module 110 over the network 104. As shown, the digital image data 114 describes a digital image 116. In the example shown, the digital image 116 is digital photograph of a skyline and individuals viewing the skyline. Of course, the digital image 116 could be a rendering of nearly anything that can be rendered on a screen of a digital device. The input data 120 is shown as describing an input stroke 122 superimposed on the digital image 116. Of course, the input stroke 122 can be any of a variety of strokes created (e.g., drawn) by a user or other provided (e.g., automatically by a computerized system).

As can be seen in the example environment 100, the controller module 110 projects the digital image 116 and the input stroke 122 onto a user interface 124. The input stroke 122 starts at a first point 126 that is at or adjacent a first edge 128, traces or outlines above the individuals in the digital image 116 and ends at a second point 130 that is at or adjacent a second edge 132 of the digital image 116 with a connection 134 extending from the first point 126 to the second point 130.

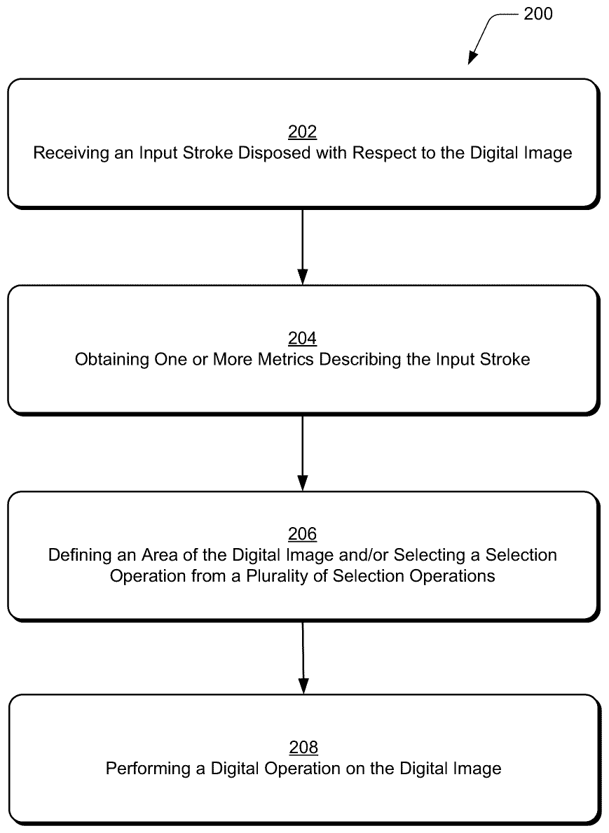

FIG. 2 illustrates a flow diagram of an example methodology or technique 200 for determining an area of a digital image and for performing a digital operation on the digital image. According to the example procedure 200, an area of the digital image is determined and the digital operation is performed on the digital image by the following steps: i) at block 202, an input stroke disposed with respect to the digital image is received; ii) at block 204, one or more metrics are obtained, typically in real-time, describing the input stroke; iii) at block 206, an area of the digital image is defined and/or a selection operation is selected from a plurality of selection operations; and iv) at block 208, a digital operation is performed on the digital image. Typically, the digital operation at block 208 is performed on the selected area of the digital image. However, the digital operation at block 208 may be performed elsewhere on the digital image (e.g., on the entire digital image except the determined area). In this latter situation, it is contemplated that the digital operation being performed a mask operation that is performed on the determined area.

The input stroke can be received according to a variety of protocols. It is contemplated that the input stroke may be machine generated, for example by artificial intelligence or machine learning. Typically, however, the input stroke is received from a user creating the input stroke with the intention of identifying an area of a digital image. A user may, for example, use a mouse to move a cursor over a digital image to select an area of the digital image. A user may use a finger or stylus on a touch screen to select an area of the digital image. The skilled artisan will be able to think of multiple mechanisms for producing an input stroke relative to a digital image that are usable for the techniques described herein. Typically, the input stroke, however received, will leave a visible track superimposed over the digital image showing the shape of the input stroke and the location of the stroke relative to features of the digital image. In this manner, at least some level of feedback is provided as to the area that is being selected. This is particularly helpful for a user provided input stroke since the user gets some feedback as to the area that is being selected, typically in real-time as the input stroke is created.

The input stroke is typically a single continuous stroke that includes a first point, typically a start and/or distal point, and a second point, typically an end and/or distal point and a connector that extends continuously from the first point to the second point. However, it is contemplated that the input stroke could be provide in multiple parts. For example, a user might make a portion of an input stroke that outlines over the top of an object in a digital image and then make a portion of the input stroke that outlines below the bottom of an object in a digital image.

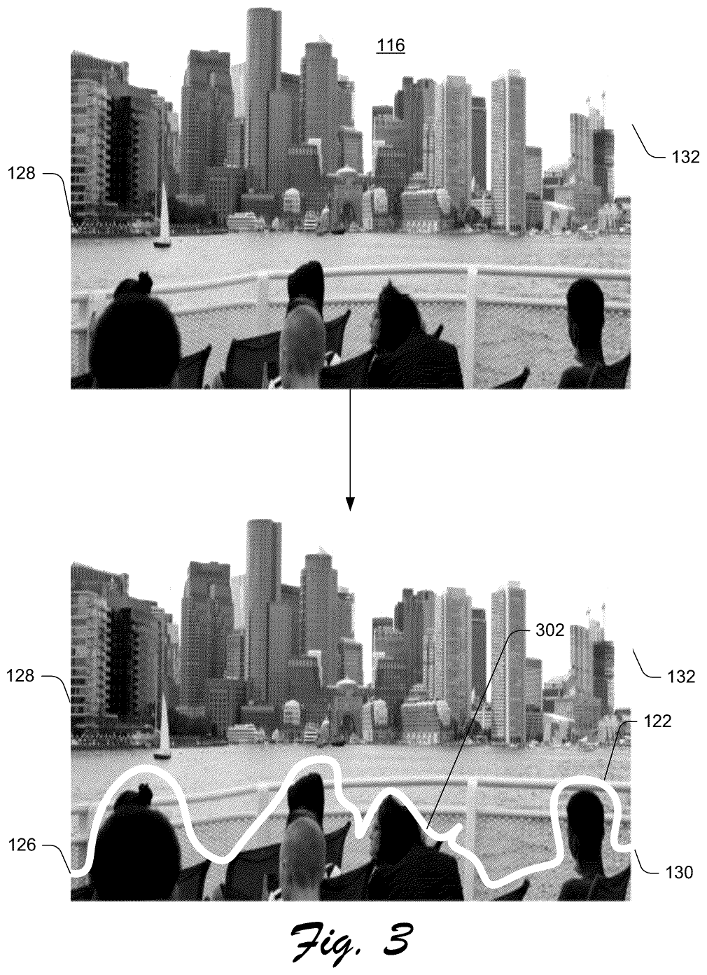

With reference to FIG. 3, there is illustrated an example implementation of receiving the input stroke 122 on the digital image 116 from FIG. 1. In the implementation, a user has started at the first point 126 and outlines above the individuals in the digital image 116 with a connector 302 continuously to the second point 130. As shown, the first point 126 is adjacent the first edge 128 of the digital image 116 and the second point 130 is adjacent the second edge 132 of the digital image 116.

### Selection Operations

In one implementation of methods and systems described herein, the input stroke is classified or determined as corresponding to a particular selection operation based upon the metrics of the input stroke. The selection operation is typically selected from a plurality of selection operations. Examples of selection operations include, without limitation, a brush operation, a lasso operation and a filling mask operation.

A lasso operation, as used herein, is an operation in which the area selected for a digital operation is substantially entirely defined by an input stroke alone or by the input stroke and one or more edges of the digital image. In such an operation, the input stroke typically defines as at least a portion or substantially the entirety of an outer perimeter of the area selected for a digital operation.

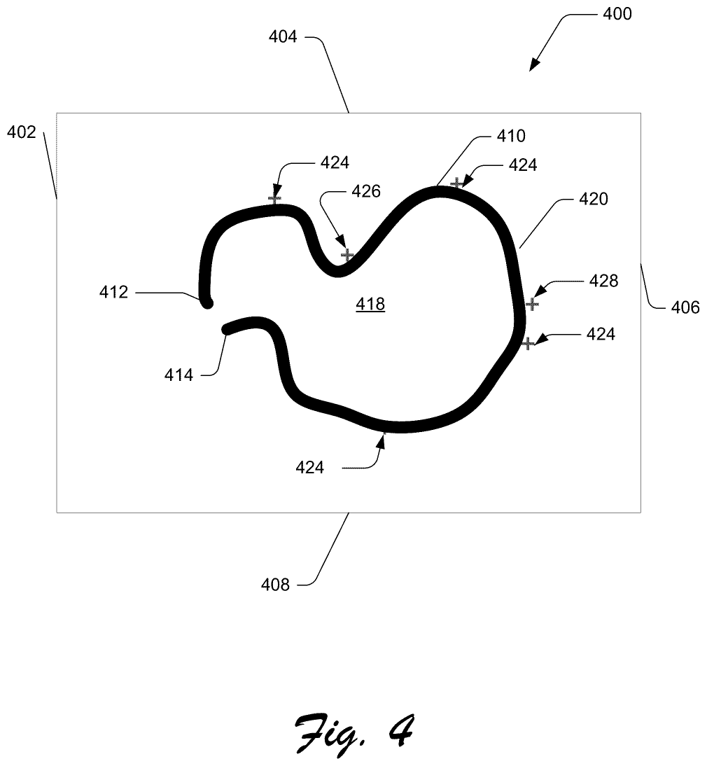

If the input stroke substantially entirely defines the outer perimeter of the selected area, the lasso operation is referred to herein as an internal lasso operation. As used herein to define the outer perimeter of an area, the term “substantially entirely” means that at least 80%, more typically at least 90% and even more typically at least 95% of the perimeter of the area is defined by the input stroke. FIG. 4 illustrates a schematic of a digital image 400 (i.e., schematic in the sense that only edges 402, 404, 406 and 408 of the digital image 400 are shown without content of the digital image). An input stroke 410 has been received and superimposed over the image 400. By its metrics, the input stroke 410 is classified as corresponding to a lasso operation, and more particularly an internal lasso operation. As can be seen, a first point 412 (e.g., a start and/or distal point) of the input stroke 410 is adjacent to a second point 414 (e.g., an end and/or distal point) of the input stroke 400. Moreover, the input stroke 410 substantially entirely defines an outer perimeter of a selected area 418 upon which a digital operation is to be performed.

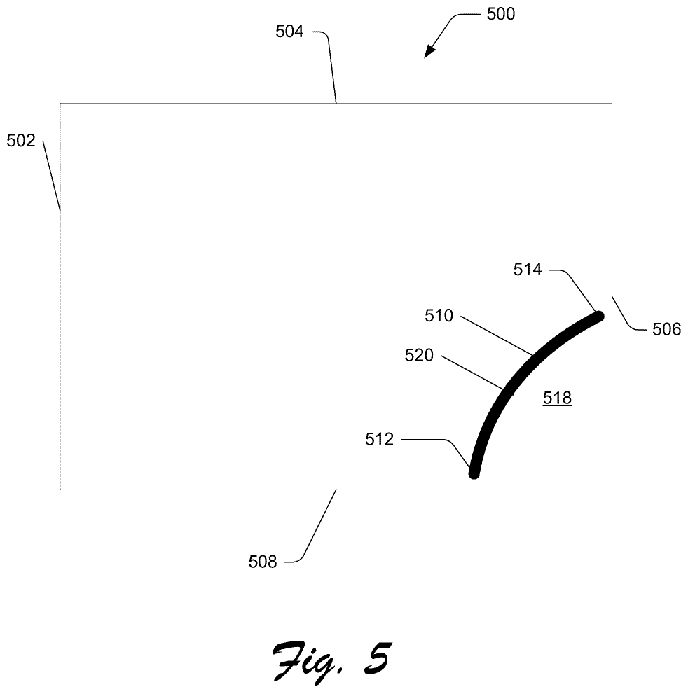

If the input stroke substantially entirely defines the outer perimeter of the selected area in conjunction with one or more edges of the digital image, the lasso operation is referred to herein as an edge lasso operation as opposed to an internal lasso operation. As used herein to define the outer perimeter of an area, the term “substantially entirely” means that at least 80%, more typically at least 90% and even more typically at least 95% of the perimeter of the area is defined by the input stroke and one or more edges of the digital image. FIG. 5 illustrates a schematic of a digital image 500 (i.e., schematic in the sense that only edges 502, 504, 506 and 508 of the digital image 500 are shown without content of the digital image). An input stroke 510 has been received and superimposed over the image 500. By its metrics, the input stroke 510 is classified as corresponding to a lasso operation, and more particularly an edge lasso operation. As can be seen, a first point 512 (e.g., a start and/or distal point) of the stroke is adjacent to a first edge 508 and a second point 514 (e.g., an end and/or point) of the input stroke 510 is located adjacent a second edge 506 of the digital image 500. Moreover, the input stroke 510 in conjunction with the first edge 508 and the second edge 506 substantially entirely defines an outer perimeter of a selected area 518 upon which a digital operation is to be performed.

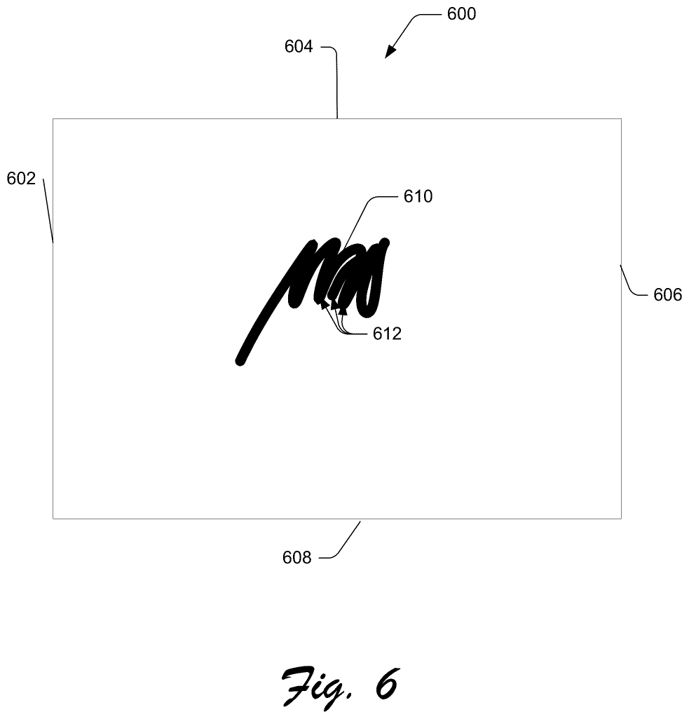

If the input stroke defines the area of the digital image as disposed substantially entirely underneath the input stroke, the selection operation is typically defined or classified as a brush operation. As used herein as defining the area, the term “substantially entirely” means that at least 80%, more typically at least 90% and even more typically at least 95% of the area is covered by the input stroke. FIG. 6 illustrates a schematic of a digital image 600 (i.e., schematic in the sense that only edges 602, 604, 606 and 608 of the digital image 600 are shown without content of the digital image). An input stroke 610 has been received and superimposed over the image 600. By its metrics, the input stroke 610 is classified as corresponding to a brush operation. As can be seen, the input stroke 610 has multiple portions 612 adjacent and/or overlapping each other for covering an area 614 upon which a digital operation is to be performed.

### Metrics

According to techniques described herein, one or more metrics are obtained, and those metrics describe the input stroke. This is shown at 204 within the example methodology 200 of FIG. 2. The metrics may be obtained while the stroke is being applied to the digital image in real-time and/or after the stroke has been applied to the digital image. The metrics are, at least in part, employed to determine the area that is being selected by the input stroke and/or determining the selection operation that is used to identify that area. As suggested, the metrics of the input stroke can include, without limitation, accumulative angle, open-to-total distance ratio, number of deflection points, number of reflection points, distance-to-area ratio, edge adjacency, point adjacency and so on. It shall be understood that any combination of these metrics may be employed determining the area that is being selected by the input stroke and/or determining the selection operation that is used to identify the area.

Accumulative angle is one metric useful for determining the area that is being selected by the input stroke and/or determining the selection operation that is used to determine the area. Accumulative angle is a determination of change in the direction along the input stroke in terms of the angle between the present direction of the input stroke and one or more preceding directions of the input stroke. The accumulative angle can be computed and analyzed as an input stroke is being created or thereafter. The accumulative angle changes along an input stroke as the direction of the input stroke changes and the magnitude of change in accumulative angle typically corresponds to the degree of change in direction. Thus, for quick and/or sharp contours of the input stroke, the magnitude of change of the accumulative angle is more significant than for gradual contours or straight portion of the input stroke. For example, the accumulative angle of the input stroke 410 of the lasso operation shown in FIG. 4 will change in accordance with the contours (e.g., curves, turns and so on) shown for the input stroke 410 but since the input stroke 410 has no particularly fast changing contours (e.g., sharp turns such as turns greater than 90 degrees), the magnitude of change of the accumulative angle does is not particularly significant (e.g., high) along the input stroke. As a contrasting example, the input stroke 610 of brush operation shown in FIG. 6 has several quickly changing contours (e.g., sharp turns such as turns greater than 90 degrees). As shown, the portions 612 are connected to each other with sharp (e.g., near 180 degree) turns. The magnitude of change of the accumulative angle for these quickly changing contours will be quite significant (e.g., high). Thus, multiple changes of magnitude of the accumulative angle that exceed a predetermined threshold can be indicative of a brush operation. A lack of such changes of magnitude of accumulative angle is typically indicative of a lasso operation.

Cumulative number of deflection points is another metric useful for determining the area that is being selected by the input stroke and/or determining the selection operation that is used to determine the area. A deflection point is a change of direction of a predetermined number of degrees (e.g., 30, or 90 degrees) of an input stroke. Tracking the cumulative number of deflection points aids in determining whether an internal lasso operation is intended by an input stroke. The cumulative number of deflection points is calculated herein by determining a number of deflection points in a first direction (i.e., clockwise or counterclockwise) subtracted by a number of deflection points in second direction (i.e., clockwise or counterclockwise). If the cumulative number of deflection points multiplied by the predetermined number of degrees of the change of direction for those deflection points is equal to 270 degrees (either negative or positive depending upon how the calculation is performed), then it is more likely that an internal lasso operation is intended by the input stroke. With reference to FIG. 4, it can be seen that the input stroke 410 has four (4) deflection points 424 (shown with cross symbols) of ninety (90) degrees in a clockwise direction and one (1) deflection point 426 (shown with a cross symbol) of ninety (90) degrees is a counterclockwise direction such that the cumulative number of deflection points is three (3). Thus, for the input stroke 410 of FIG. 4, the cumulative number of deflection points (i.e., three) multiplied by the predetermined number of degrees (i.e., ninety) for the deflection points is 270 degrees and the input stroke is deemed to likely be intended as an internal lasso operation.

Cumulative number of reflection points is another metric useful for determining the area that is being selected by the input stroke and/or determining the selection operation that is used to identify the area. A reflection point is any change of direction of the input stroke toward or away from a distal point (e.g., a start or end point) of the input stroke. Tracking the cumulative number of reflection points also aids in determining whether an internal lasso operation is intended by an input stroke. The cumulative number of reflection points is calculated herein by determining a number of reflection points back toward the distal end subtracted by a number of reflection points away from the distal. If the cumulative number of reflection points is one (1) as opposed to zero (0), then the input stroke is more likely to be an internal lasso operation. With reference to FIG. 4, it can be seen that the input stroke 410 has one (1) reflection point 428 (shown with a cross symbol) wherein the input stroke 410 has a change of direction toward the distal end 412 of the input stroke 410 and no change of direction after that reflection point 428 back away from the distal point 412. Thus, for the input stroke 410 of FIG. 4, the cumulative number of reflection points is one (1) and the input stroke is deemed to likely be intended as an internal lasso operation.

Open-to-total distance ratio is another metric useful for determining the area that is being determined by the input stroke and/or selecting the selection operation that is used to identify the area. Open-to-total distance ratio is a comparison of the total length of an input stroke as it extends from a first distal point of the input stroke to a second distal point of the input stroke relative to the shortest distant between the first and second distal points. Tracking the open-to-total distance ratio aids in determining whether an internal lasso operation is intended by an input stroke as opposed to a brush operation or an edge lasso operation. If the total length of the input stroke as it extends between the distal points is high relative to the shortest length between the distal points, then the input stroke is more likely to be an internal lasso operation. With reference to FIG. 4, it can be seen that the total distance of the input stroke 410 from the first distal point 412 of the input stroke 410 to the second distal point 414 of the input stroke 410 is quite long relative to the shortest distance between the distal points 412, 414 suggesting that the input stroke 410 is intended as an internal lasso operation. In contrast, the total distance of the input strokes 510, 610 of FIGS. 5 and 6 extending between distal ends of those input stroke 510, 610 are short relative to the shortest distance between those distal ends suggesting that the intent of those input strokes 510, 610 is less likely to be an internal lasso operation.

Total distance-to-area ratio is yet another metric useful for determining the area that is being selected by the input stroke and/or selecting the selection operation that is used to identify the area. Total distance-to-area ratio is a comparison of the total length of an input stroke as it extends from a first distal point of the input stroke to a second distal point of the input stroke relative to the area that the input stroke would enclose if the first and second distal points were connected by a connector (e.g., a line segment). Tracking the total distance-to-area ratio aids in determining whether an internal lasso operation is intended by an input stroke as opposed to, for example, a brush operation or an edge lasso operation. If the total length of the input stroke as it extends between the distal points is short relative to the area that would be enclosed by the input stroke and connector, then the input stroke is more likely to be an internal lasso operation. With reference to FIG. 4, it can be seen that the total distance of the input stroke 410 from the first distal point 412 of the input stroke 410 to the second distal point 414 of the input stroke 410 is short relative to the area 418 that is enclosed by the input stroke 410 and a connector (e.g., line segment not shown) that would connect the first distal point 412 to the second distal point 414 suggesting that the input stroke 410 is intended as an internal lasso operation.

Edge adjacency is a metric that determines whether a first point and a second point, which are typically distal points, of the input stroke are near to one or more edges of a digital image. Typically, edge adjacency of an input stroke suggests that an edge lasso operation is intended by the input stroke. As a baseline, edge adjacency for an input stroke is achieved if the first point and the second point are both within a threshold distance from the one or more edges. Multiple additional factors can also be considered for determining if an input stroke satisfies the metric of edge adjacency, however none of these factors are required unless otherwise specifically stated. As an example, if both or either of the first point and the second point of the input stroke are a start point or an end point of the stroke suggest that the input stroke satisfies the metric of edge adjacency. As another example, the first point and the second point of the input stroke being distal points of the stroke can be a factor suggesting edge adjacency. For determining edge adjacency, a connector of the input stroke typically extends from the first point to the second point, although not required unless otherwise stated. The connector is also typically continuous between the first point and the second point, although not required unless specifically stated. With reference to the example of FIG. 5, the first point 512 is a first and distal point that is within a threshold distance from the first edge 508 and the second point 514 is a second and end point that is within a threshold distance from the second edge 506. As can also be seen, the input stroke 510 is comprised of a connector 520 extending continuously from the first point 512 to the second point 514. As such, the input stroke 510 achieves edge adjacency.

Point adjacency is a metric that determines whether a first point and a second point of the input stroke are near to each other. Typically, point adjacency of an input stroke suggests that an internal lasso operation is intended by the input stroke. As a baseline, point adjacency for an input stroke is achieved if the first point and the second point are within a threshold distance from each other. Multiple additional factors can also be considered for determining if an input stroke satisfies the metric of point adjacency, however none of these factors are required unless otherwise specifically stated. As an example, the first point and the second point of the input stroke both being either a start point or an end point of the stroke can be a factor suggesting point adjacency. As another example, the first point and the second point of the input stroke being distal points of the stroke can be a factor suggesting point adjacency. For determining point adjacency, a connector of the input stroke typically extends from the first point to the second point, although not required unless otherwise stated. The connector is also typically continuous between the first point and the second point, although not required unless specifically stated. With reference to the example of FIG. 4, the first point 412 a first and distal point and is within a threshold distance from the second point 414, which is end and distal point. As can also be seen, the input stroke 410 is comprised of a connector 420 extending continuously from the first point 412 to the second point 514. As such, the input stroke 510 achieves point adjacency.

In implementations of the methods and systems described herein, the metrics are used to determine a selection operation from a plurality of selection operations to, in turn, aid in determining an area of a digital image upon which a digital operation is to be performed. The skilled artisan will understand that the determination of the selection operation can be based solely or partially upon the metrics. This skilled artisan will also understand that the different metrics can be given more or less weight in determining the selection operation to be applied depending upon a variety of factors. For example, the metric of edge adjacency could be given greater weight or influence in determining whether an edge lasso operation intended by an input stroke relative to the metric of accumulative angle. As another example, the metric of accumulative angle could be given greater weight or influence in determining whether a brush operation is intended by an input stroke relative to the metric of cumulative number of deflection points.

### Digital Operations

Techniques, methods and systems described herein are useful for determining an area of a digital image upon which a variety of digital operations can be performed. Examples of digital operations including shading of the area, masking of the area, coloring of the area and so on. As one example, an area of a digital image is determined as described herein and a masking operation is performed on the area such that the area is unchanged by a subsequent operation performed on the digital image. As another example, an area of a digital image is determined as described herein and a brightening operation is performed on the area that was determined. The skilled artisan will be able to imagine a variety of digital operations for which determining an area of a digital image is useful.

The techniques, methods and systems described herein have been found particularly desirable for performance of a distractor removal operation on a digital image. Typically, for such operation, the area of the digital image is determined in accordance with techniques described herein and the area will include a distractor that is to be removed. Thereafter, the distractor is identified within the selected area and removed. In one implementation, an inpainting operation is used to not only remove the distractor, but also to replace (e.g., cover) the distractor with other content designed to make the digital image appear as if the distractor was never in the digital image.

For performing distractor removal from digital images in accordance with teachings disclosed herein, in one implementation, a user or machine outlines a distractor with an input stroke for identifying the area that includes the distractor and then allows or signals a distractor removal operation to be performed. Alternatively, in another implementation, a user or machine covers a distractor with an input stroke to identify the area that includes the distractor and then allows or signals a distractor removal operation to be performed.

In one implementation, a computer application has the capability to perform multiple different digital operations on a digital image, perhaps even creating a digital image. In such implementation, the application typically provides multiple tools respectively corresponding to the multiple different operations. Then, depending upon the tool/operation selected, the computer application will or will not use the techniques described herein for determining an area of a digital image. Advantageously, for those tools that use the techniques described herein, switching between types of selection operations can often be avoided. For example, the system or methodology automatically determines a selection operation (e.g., an edge lasso operation) from a plurality of selection operations (e.g., an edge lasso operation, an internal lass operation, a brush operation and so on) without involving a user input to switch between the selection operations. In such an implementation, one of the tools can be a distractor removal operation tool, which may or may not include an inpainting operation function, and, once the tool is selected, the techniques described herein can be used to identify the area of the digital image that includes the distractor. In this manner, one or more distractors can be rapidly removed from a digital image and, if such functionality is included, the location of the distractor inpainted.

In an alternative implementation, a computer application is dedicated to distractor removal and may or may not include an inpainting operation function. In such alternative implementation, a digital image can simply be accessed by the application and the techniques described herein can be used to identify the area of the digital image that includes the distractor. Advantageously, the techniques described herein can be used to identify and remove distractor and switching between types of selection operations can often be avoided. In this manner, one or more distractors can be rapidly removed from a digital image and, if such functionality is included, the location of the distractor inpainted. The methods and techniques described herein can be implemented by a variety of systems.

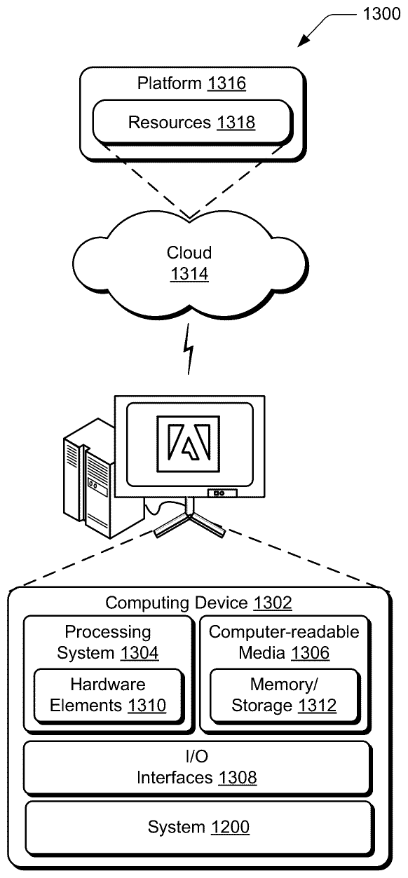

With reference to FIG. 12, an example system 1200 is shown as integrated with components of the system 100 of FIG. 1. As can be seen, a determination area module 1202, a digital operation module 1204, and a rendering module 1206 have been integrated into the controller module 110. It shall be understood, however, that these modules can be integrated into various component of a great many systems.

The determination area module (e.g., a distractor area module) is at least partially implemented in hardware of a computing device. The determination area module can perform any tasks or techniques associated with determining the area upon which a digital operation (e.g., distractor removal) is to be performed including any tasks associated with identifying a selection operation as described herein. The digital operation module (e.g., a distractor removal module) implemented at least partially in the hardware of the computing device to perform all aspects of a selected digital operation such as identifying and removing a distractor from the area of a digital image. Further, the system will also typically include a rendering module implemented at least partially in hardware of the computing device to display the digital image before and/or after a digital operation is performed on the digital image.

### Examples

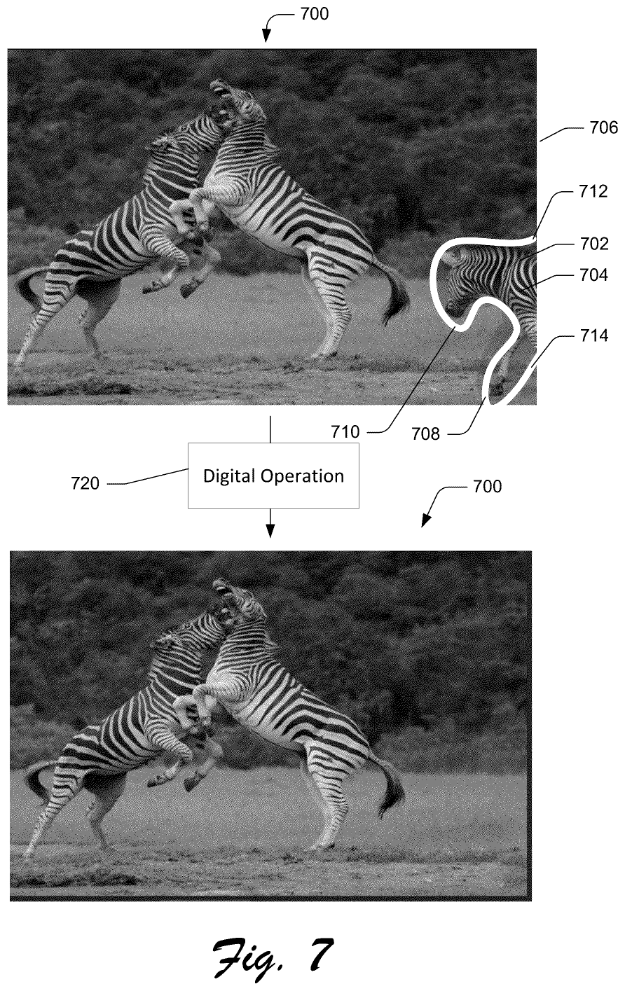

Referring to FIG. 7, an example of a digital image 700 and the determination of an area 702 of that digital image 700 is illustrated. The digital image 700 includes a distractor 704 (i.e., a zebra) adjacent an edge 706 of the digital image 700. As can be seen, an input stroke 708 has been received, and the input stroke 708 includes a connector 710 that extends from a first distal point 712 of the input stroke 708, about the distractor 704, and to a second distal point 714 of the input stroke 708. The first point 712 is adjacent (e.g., within a threshold distance from) the edge 706 of the digital image 700 and the second point 714 is also adjacent (e.g., within a threshold distance from) the edge 706 of the digital image 700. Accordingly, the input stroke 708 (e.g., the connector 710) and the edge 706 define the area 702 that includes the distractor 704. As such, the input stroke 708 satisfies the metric of edge adjacency and an edge lasso operation is selected as a selection operation to, in turn, select the entirety of the area 702 of the digital image 700. As can also be seen, a digital operation 720, in particular a distractor removal operation, that includes inpainting, is performed on the digital image 700 such that the digital image is generated without the distractor 702.

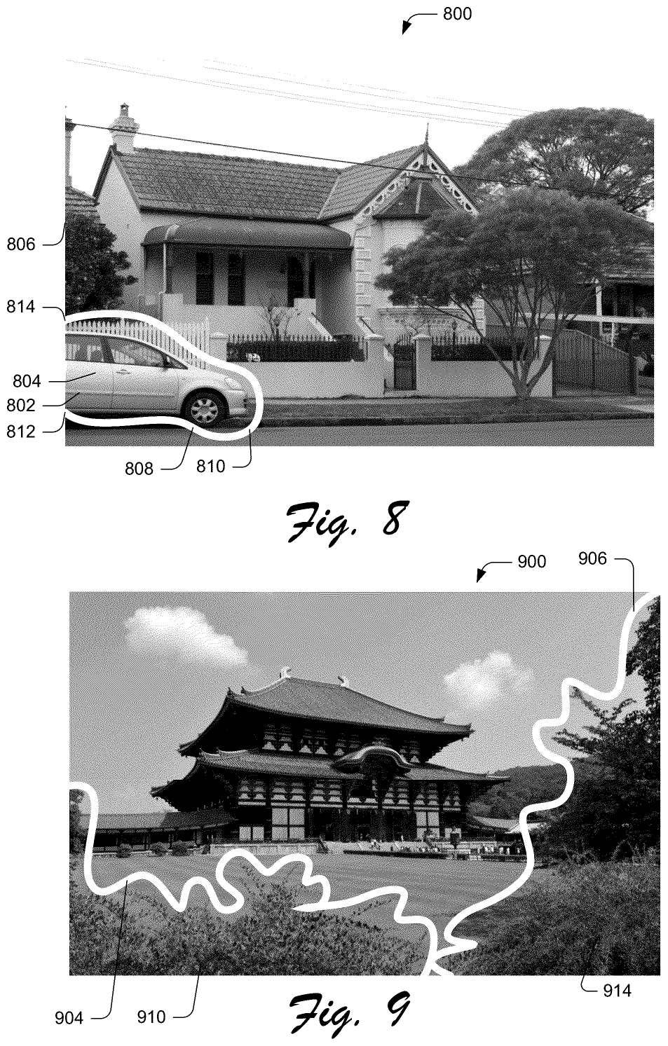

Referring to FIG. 8, another example of a digital image 800 and selection of an area 802 of that digital image 800 is illustrated. The digital image 800 includes a distractor 804 (i.e., a vehicle) adjacent an edge 806 of the digital image 800. As can be seen, an input stroke 808 has been received, and the input stroke 808 includes a connector 810 that extends from a first distal point 812 of the input stroke 808, about the distractor 804, and to a second distal point 814 of the input stroke 808. The first point 812 is adjacent (e.g., within a threshold distance from) the edge 806 of the digital image 800 and the second point 814 is also adjacent (e.g., within a threshold distance from) the edge 806 of the digital image 800. Accordingly, the input stroke 808 (e.g., the connector 810) and the edge 806 define the area 802 that includes the distractor 804. As such, the input stroke 808 satisfies the metric of edge adjacency and an edge lasso operation is selected as a selection operation to, in turn, select the entirety of the area 802 of the digital image 800. Like that shown in FIG. 7, a digital operation, in particular a distractor removal operation that includes inpainting, can be performed on the digital image 800 such that the digital image is generated without the distractor 802.

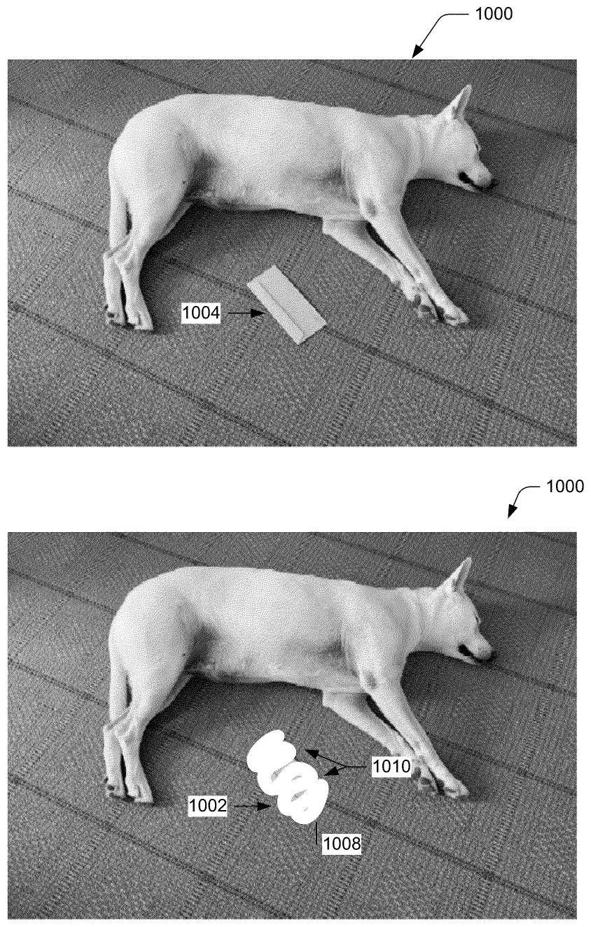

Referring to FIG. 9, another example of a digital image 900 and determination of areas of that digital image 900 are illustrated. As can be seen, two input strokes 904, 906 are illustrated. In a manner similar to FIGS. 7 and 8, the input stroke 904 indicates an edge lasso operation is performed on a first area 910 having a first distractor and, separately, input stroke 906 indicates an edge lasso operation is performed on a second area 914 having second distractor.

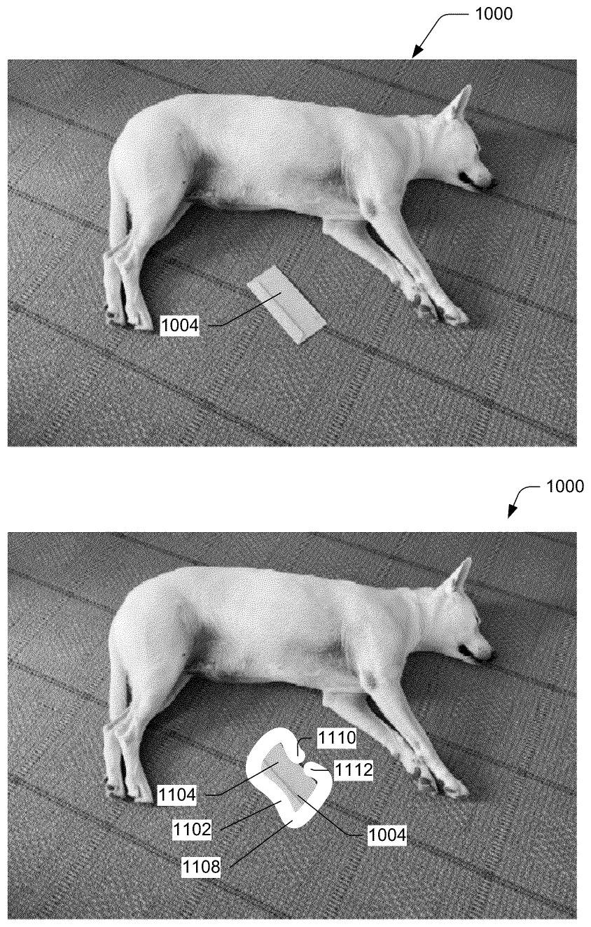

Referring to FIG. 10, another example of a digital image 1000 and determination of an area 1002 of the digital image 1000 is illustrated. The digital image 1000 and/or the area 1002 includes a distractor 1004 (i.e., an envelope) located at an internal position of the digital image 1000. As can be seen, an input stroke 1008 has been received, and the input stroke 1008 includes several rapidly changing contours 1010 such that the accumulative angle of the input stroke 1008 indicates that the intended selection operation of the input stroke 1008 is a brush operation covering substantially the entirety of the area 1002 including the distractor 1004. Accordingly, a digital operation, in particular a distractor removal operation that includes inpainting, can be performed on the digital image 1000 such that the digital image 1000 can be generated without the distractor 1004.

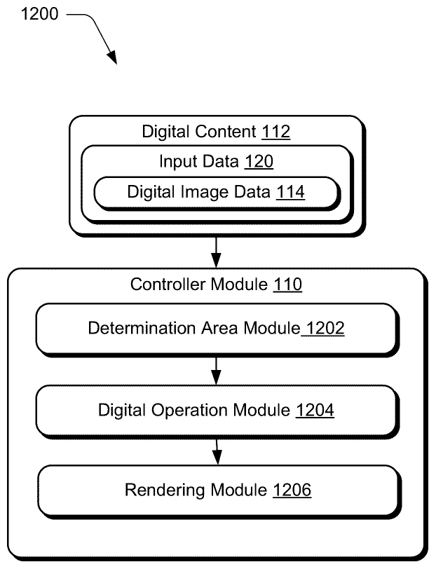

Referring to FIG. 11, the digital image 1000 of FIG. 10 is repeated with a different example of an input stroke 1102 for selection of an area 1104 of that digital image 1000. The digital image 1000 includes the distractor 1004 (i.e., the envelope). As can be seen, the input stroke 1102 has been received, and the input stroke 1102 includes a connector 1108 that extends from a first distal point 1110 of the input stroke 1102, about the distractor 1004, and to a second distal point 1112 of the input stroke 1102. The first point 1110 is adjacent (e.g., within a threshold distance from) the second point 1112. Accordingly, the input stroke 1102 (e.g., the connector 1108) defines the area 1104 that includes the distractor 1004. As such, the input stroke 1102 satisfies the metric of point adjacency and an internal lasso operation is selected as a selection operation to, in turn, select the entirety of the area 1104 of the digital image 1000. Like that shown in FIG. 7, a digital operation, in particular a distractor removal operation that includes inpainting, can be performed on the digital image 1000 such that the digital image is generated without the distractor 1004.

### Example System and Device

FIG. 13 illustrates an example system 1300 that includes an example computing device 1302 that is representative of one or more computing systems and/or devices that are usable to implement the various techniques described herein. The example system 1300 includes the system 1200 of FIG. 12 and can, for instance, be utilized to carry out the methodology 200 shown in FIG. 2. The computing device 1302 includes, for example, a server of a service provider, a device associated with a client (e.g., a client device), an on-chip system, and/or any other suitable computing device or computing system.

The example computing device 1302 as illustrated includes a processing system 1304, one or more computer-readable media 1306, and one or more I/O interfaces 1208 that are communicatively coupled, one to another. Although not shown, the computing device 1302 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1304 is representative of functionality to perform one or more operations using hardware. Accordingly, the processing system 1304 is illustrated as including hardware elements 1310 that are configured as processors, functional blocks, and so forth. This includes example implementations in hardware as an application specific integrated circuit or other logic device formed using one or more semiconductors. The hardware elements 1310 are not limited by the materials from which they are formed, or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1306 is illustrated as including memory/storage 1312. The memory/storage 1312 represents memory/storage capacity associated with one or more computer-readable media. In one example, the memory/storage 1312 includes volatile media (such as random access memory (RAM)) and/or nonvolatile media (such as read only memory (ROM), Flash memory, optical disks, magnetic disks, and so forth). In another example, the memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1302. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1310. For example, the computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing system 1304. The instructions and/or functions are executable/operable by one or more articles of manufacture (for example, one or more computing devices 1302 and/or processing systems 1304) to implement techniques, modules, and examples described herein.

The techniques described herein are supportable by various configurations of the computing device 1302 and are not limited to the specific examples of the techniques described herein. This functionality is also implementable entirely or partially through use of a distributed system, such as over a “cloud” 1314 as described below.

The cloud 1314 includes and/or is representative of a platform 1316 for resources 1318. The platform 1316 abstracts underlying functionality of hardware (e.g., servers) and software resources of the cloud 1314. For example, the resources 1318 include applications and/or data that are utilized while computer processing is executed on servers that are remote from the computing device 1302. In some examples, the resources 1318 also include services provided over the Internet and/or through a subscriber network, such as a cellular or Wi-Fi network.

The platform 1316 abstracts the resources 1318 and functions to connect the computing device 1302 with other computing devices. In some examples, the platform 1316 also serves to abstract scaling of resources to provide a corresponding level of scale to encountered demand for the resources that are implemented via the platform. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

### CONCLUSION

Although implementations of systems for selecting areas of digital images have been described in language specific to structural features and/or methods, it is to be understood that the appended claims are not necessarily limited to the specific features or methods described. Rather, the specific features and methods are disclosed as example implementations of systems for selecting area of digital images, and other equivalent features and methods are intended to be within the scope of the appended claims. Further, various different examples are described, and it is to be appreciated that each described example is implementable independently or in connection with one or more other described examples.

What is claimed is:

1. A method comprising:
receiving, by a processing device, an input with respect to a digital image, the input specifying a first point, a second point, and a connection between the first point and the second point;
detecting, by the processing device, the first point and the second point are disposed proximal to one or more edges of the digital image;
responsive to the detecting, defining, by the processing device, an area of the digital image based on the first point, the second point, and the connection;
selecting, by the processing device, the area automatically and without user intervention; and
generating, by the processing device, an edited digital image by applying a digital image editing operation to the selected area.

2. The method as described in claim 1, wherein the detecting of the first point and the second point includes determining that the first point and the second point are within a threshold distance from the one or more edges.

3. The method as described in claim 1, wherein the one or more edges is selected from a single edge or a first edge and a second edge from a plurality of edges of the digital image.

4. The method as described in claim 1, further comprising generating one or more metrics by analyzing the connection, the one or more metrics including an accumulative angle, an open-to-total distance ratio, a number of deflection points, a number of reflection points or a distance-to-area ratio.

5. The method as described in claim 1, wherein the digital image editing operation includes removal of a distractor from the digital image.

6. The method as described in claim 1, wherein the digital image editing operation includes an inpainting operation.

7. The method as described in claim 1, wherein the connection does not intersect with itself.

8. A system comprising:
a non-transitory computer readable storage media; and
a processing device in communication with the non-transitory computer readable media, the processing device configured to perform operation including:
receive, via a user interface, an input stroke disposed with respect to a digital image;
obtain metrics describing the input stroke;
classifying the input stroke as corresponding to a particular selection operation from a plurality of selection operations based on the metrics;
performing the particular selection operation, the particular selection operation selecting an area of the digital image automatically and without user intervention;
selecting a distractor within the area of digital image based on the particular selection operation using the input stroke; and
generating an edited digital image by removing the distractor from the digital image.

9. The system as described in claim 8, wherein the input stroke and the metrics are used to define an area of the digital image and wherein the distractor is within the area of the digital image.

10. The system as described in claim 8, wherein the metrics include an accumulative angle, an open-to-total distance ratio, a number of deflection points, a number of reflection points, or a distance-to-area ratio.

11. The system as described in claim 8, wherein the generating is performed using an inpainting operation.

12. The system as described in claim 8, wherein the input stroke is classified as an internal lasso operation based at least in part upon the input stroke including a first point of the input stroke within a threshold distance of a second point of the input stroke such that the area of the digital image is defined by a connection between the first point and the second point.

13. The system as described in claim 8, wherein the input stroke is classified as an edge adjacent lasso operation based at least in part upon the input stroke including a first point of the input stroke within a threshold distance of one or more edges of the digital image and a second point of the input stroke within a threshold distance of the one or more edges such that the area of the digital image is defined by the one or more edges and a connection between the first point and the second point.

14. The system as described in claim 8, wherein the input stroke is classified as a brush stroke, the brush stroke defining the area of the digital image as disposed underneath the input stroke in the user interface.

15. A system comprising:
a computing device having hardware;
a distractor area module implemented at least partially in the hardware of the computing device, the distractor area module configured to:
detect an input stroke on a digital image;
classify the input stroke; and
select an area of the digital image based upon the input stroke;
a distractor removal module implemented at least partially in the hardware of the computing device to identify and remove a distractor from the area of the digital image; and
a rendering module implemented at least partially in hardware of the computing device to display the digital image having the distractor removed.

16. The system as described in claim 15, wherein removal of the distractor from the area of the digital image includes performing an inpainting operation on the area of the digital image.

17. The system as described in claim 15, further comprising analyzing the input stroke for one or more metrics selected from the group consisting of accumulative angle, open-to-total distance ratio, number of deflection points, number of reflection points and distance-to-area ratio.

18. The system as described in claim 15, wherein the input stroke is classified as an internal lasso operation based at least in part upon the input stroke including a first point of the input stroke within a threshold distance of a second point of the input stroke such that the area of the digital image is defined by a connection between the first point and the second point.

19. The system as described in claim 15, wherein the input stroke is classified as an edge adjacent lasso operation based at least in part upon the input stroke including a first point of the input stroke within a threshold distance of one or more edges of the digital image and a second point of the input stroke within a threshold distance of the one or more edges such that the area of the digital image is defined by the one or more edges and a connection between the first point and the second point.

20. The system as described in claim 17, wherein the input stroke is classified as a brush stroke, the brush stroke defining the area of the digital image as disposed underneath the input stroke.
